(19) United States
(12) Patent Application Publication
(10) Pub. No.: US 2004/0222143 A1
(43) Pub. Date: Nov. 11, 2004

(54) Fuel filter device

(76) Inventors: Takeshi Kojima, Tokyo (JP); Toshihide Kimisawa, Yokohama-shi (JP); Takashi Iwamoto, Tokyo (JP); Kazumasa Kurihara, Fujisawa-shi (JP); Yasutomo Kobayashi, Yamato-shi (JP); Hiroji Sato, Tokyo (JP)

Correspondence Address: HAUPTMAN KANESAKA BERNER PATENT AGENTS, LLP, 1700 Diagonal Road, Suite 310, Alexandria, VA, 22314, US

(21) Appl. No.: 10/834,882

(22) Filed: Apr. 30, 2004

(30) Foreign Application Priority Data
Jan. 17, 2003 (JP) 2003-009878

(51) Int. Cl. B01D 24/00

(52) U.S. Cl. 210/416.4

(57) ABSTRACT

A fuel filter device includes a bag-shape filter body having an upper surface part and a lower surface part, and a space forming member disposed in the filter body for maintaining the filter body in an expanded bag-shape. At least the lower surface part has an outer layer part formed of a woven mesh and an inner layer part formed of a non-woven cloth made of an olefin resin including polyethylene and polypropylene. The fuel filter device is to be attached to a fuel intake port in a fuel tank, so that an inside of the filter body communicates with the fuel intake port.

### BACKGROUND OF THE INVENTION AND RELATED ART STATEMENT

The present invention relates to a fuel filter device to be installed on a fuel intake port inside a fuel tank.

Fuel inside a fuel tank is sent to an internal combustion engine through an intake pipe or the like disposed inside the fuel tank. A filter device is installed inside a fuel intake port of the intake pipe in order to remove water and/or a foreign material from the fuel not to be sent into a fuel pump. Japanese Patent Publication (Kokai) No. 07-148405 and Japanese Patent Publication (Kokai) No. 10-274169 have disclosed such filter devices. The filter devices have a filter body having an expanded bag shape and a shape preserving member disposed therein.

The conventional filter body in the filter device is formed of nylon. Nylon is easily soaked and swollen with fuel. As a result, a mesh size of the filter body decreases over time. When the filter body has a smaller mesh size, a pressure of the fuel increases (greater pressure loss), thereby increasing load on the fuel pump. Further, the filter body is easy to get clogged with dust and dirt, and the like, and the pressure of the fuel increases, thereby increasing load on the fuel pump.

In view of the problems described above, an object of the invention is to provide a filter device wherein it is possible to maintain a mesh size of a filter body at a predetermined size.

Further objects and advantages of the invention will be apparent from the following description of the invention.

### SUMMARY OF THE INVENTION

In order to achieve the objects described above, according to a first aspect of the invention, a fuel filter device includes a bag-shape filter body, and a space forming member disposed in the filter body for maintaining the filter body in an expanded bag shape. The fuel filter device is installed on a fuel intake port inside a fuel tank such that an internal space of the filter body communicates with the fuel intake port. The filter body includes an upper surface part and a lower surface part. At least the lower surface part includes an inner layer part formed of a non-woven cloth made of an olefin resin such as polyethylene and polypropylene, and an outer layer part formed of a woven mesh.

In the first aspect of the invention, the inner layer part is formed of the non-woven cloth made of the olefin resin, so that the inner layer part is not soaked and swollen with fuel. Accordingly, it is possible to maintain a mesh size of the inner layer part, i.e. gaps between mutually intermeshed fibers of the non-woven cloth, at a desired size. As a result, it is possible to prevent the problem in which the mesh becomes smaller over time and a pressure of the fuel increases (greater pressure loss), thereby decreasing load on the fuel pump. Further, it is possible to prevent the problem in which the filter body is easy to get clogged with dust and dirt, and the pressure of the fuel increases, thereby decreasing load on the fuel pump.

In the first aspect of the invention, the filter device has the outer layer part formed of the woven mesh. Accordingly, even if the lower surface part of the filter body rubs against a lower inner surface of the fuel tank when the lower inner surface of the fuel tank moves inwardly and outwardly (expansion and contraction of the fuel tank) due to a change in an internal pressure of the fuel tank, the inner layer part formed of the non-woven cloth does not directly contact. Accordingly, it is possible to prevent fraying in the non-woven cloth of the inner layer part due to the rubbing.

According to a second aspect of the invention, in the fuel filter device in the first aspect of the invention, the woven mesh of the outer layer part is made of an olefin resin such as polyethylene and polypropylene. Accordingly, the woven mesh of the outer layer part tends not to be soaked and swollen with the fuel, and it is possible to maintain a mesh size of the woven mesh at a desired size. When the bag-shape filter body is formed, a filter base member formed of the outer layer part and inner layer part is folded over with the inner layer part on the inside, and the folded filter base member is fused. Accordingly, the inner layer part is easily fused and integrated with the outer layer part.

According to a third aspect of the invention, in the fuel filter device in the second aspect of the invention, one of warp and woof fibers of the woven mesh of the outer layer part is formed of polyethylene, and the other of the warp and woof fibers is formed of polypropylene. The non-woven cloth of the inner layer part is formed of the fiber made of polyethylene or polypropylene. When the bag-shape filter body is formed, the filter base member formed of the outer layer part and inner layer part is folded over with the inner layer part on the inside, and the folded filter base member is fused. Accordingly, the inner layer part is easily fused and integrated with the outer layer part.

According to a fourth aspect of the invention, in the fuel filter device in the first aspect of the invention, the inner layer part is formed of a non-woven cloth layer formed with spun-bond method and a non-woven cloth layer formed with melt-blown method. In general, a non-woven cloth formed with the melt-blown method has a mesh finer than that of a non-woven cloth made with the spun-bond method. A non-woven cloth formed with the spun-bond method has a fiber with a larger diameter and higher strength. Accordingly, the non-woven cloth layer formed with the melt-blown method captures fine dust and dirt, and the non-woven cloth layer formed with the spun-bond method provides the inner layer part with rigidity, so that it is easy to maintain the shape of the filter body.

### BRIEF DESCRIPTION OF THE DRAWINGS

FIG. 1 is a sectional view of a filter device according to an embodiment of the present invention;

FIG. 2 is a plan view thereof;

FIG. 3 is a side view thereof;

FIG. 4 is a plan view of a filter base member provided with a cylindrical socket body;

FIG. 5 is a side view of the filter base member;

FIG. 6 is an enlarged bottom view of the filter base member;

FIG. 7 is an enlarged sectional view taken along line 7-7 in FIG. 4;

FIG. 8 is an enlarged sectional view taken along line 8-8 in FIG. 4;

FIG. 9 is a plan view of a space forming member;

FIG. 10 is a side view of the space forming member;

FIG. 11 is a bottom view of the space forming member; and

FIG. 12 is an enlarged sectional view of a filter body.

### DETAILED DESCRIPTION OF PREFERRED EMBODIMENTS

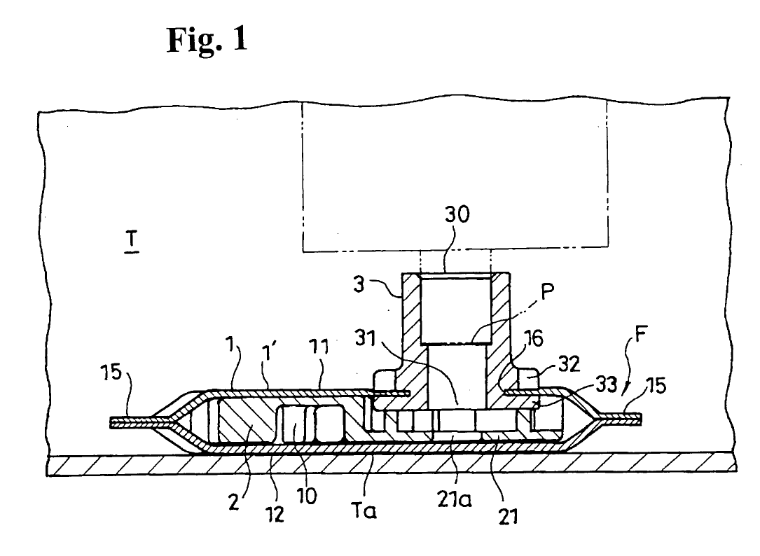

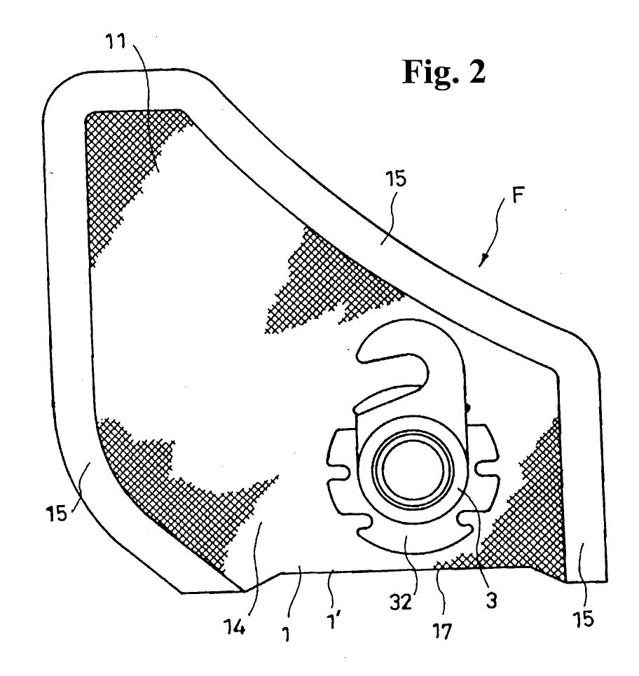

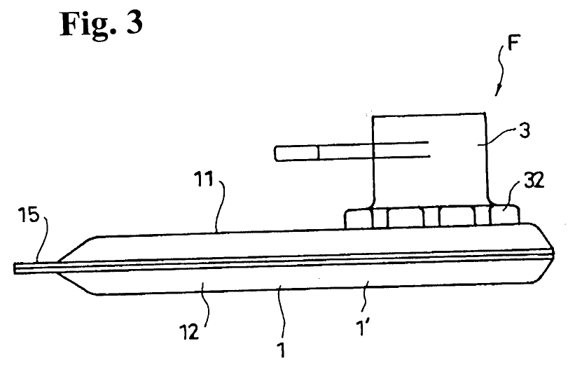

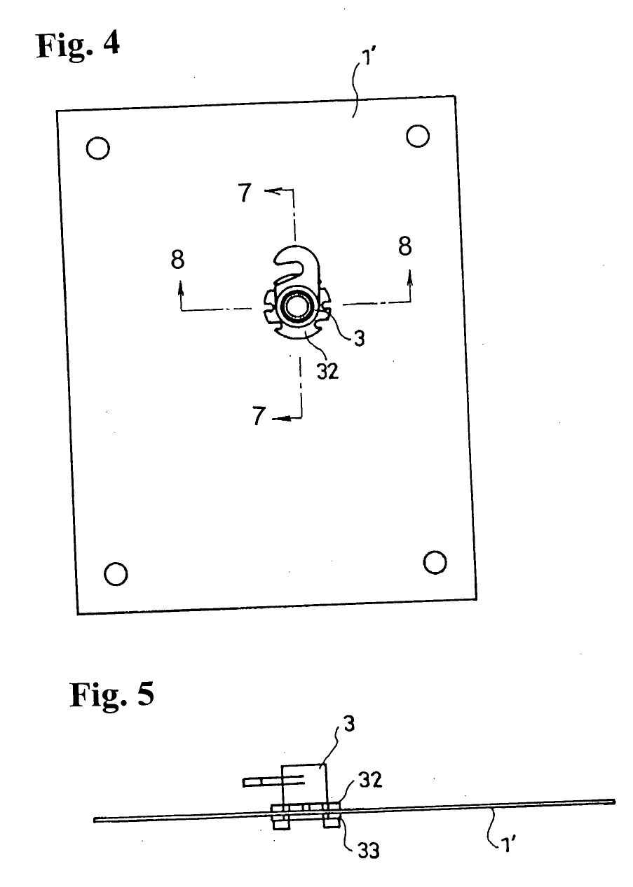

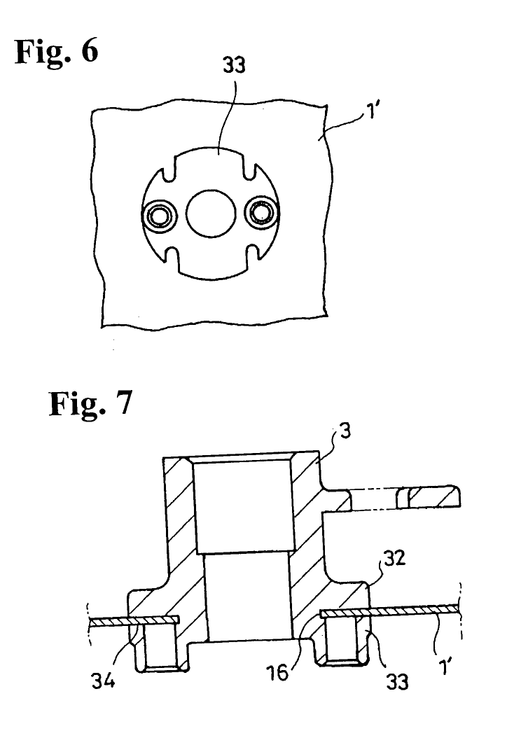

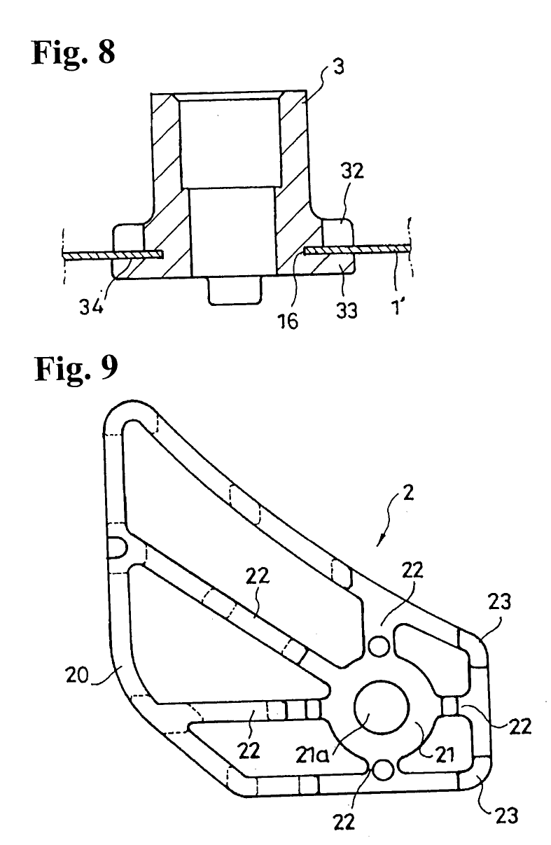

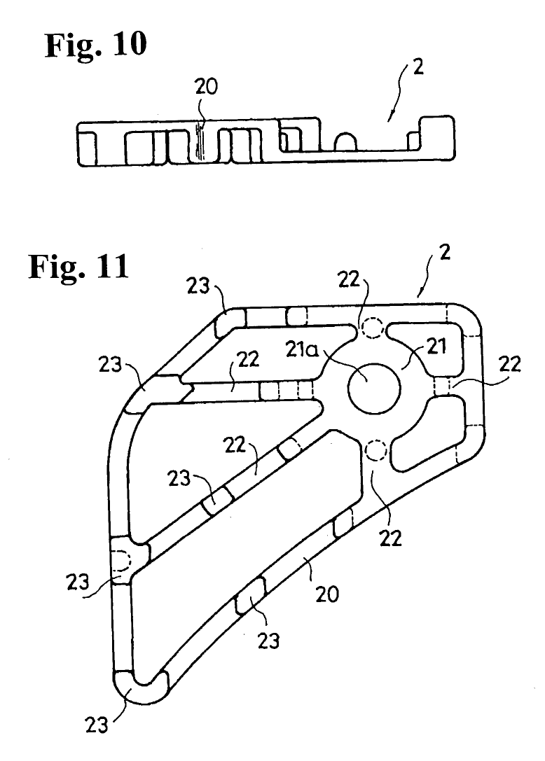

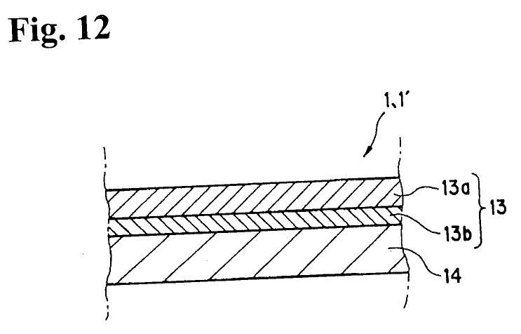

Hereunder, embodiments of the invention will be explained with reference to the accompanying drawings. FIG. 1 is a schematic view showing a state that a filter device F is installed on a fuel intake port P in a fuel tank T. FIG. 2 is a plan view of the filter device F. FIG. 3 is a side view of the filter device F. FIGS. 4 to 8 are views showing a state that a cylindrical socket body 3 is integrated with an expanded filter base member 1′ before forming a filter body 1 constituting the filter device F. FIGS. 9 to 11 are views showing a space forming member 2 housed inside the filter body 1 for maintaining the filter body 1 in an expanded shape in a state that the filter base member 1′ is integrally provided with the cylindrical socket body 3 and the filter base member 1′ is formed in a bag-shape. FIG. 12 is a sectional view showing an example of a structure of the filter body 1.

In the embodiment, the fuel filter device F is installed inside the fuel tank T of an automobile or motorcycle, or the like, for removing water and a foreign material not to be sent to an internal combustion engine through the fuel intake port P. The filter device F is generally installed on the fuel intake port P inside the fuel tank T. A fuel pump disposed inside the fuel tank T or outside the fuel tank T sends fuel to the internal combustion engine through the fuel intake port P.

The filter device F has a bag-shape filter body 1, and is installed on the fuel intake port P such that an internal space 10 of the bag-shape filter body 1 communicates with the fuel intake port P. The filter device F has a space forming member 2 housed inside the filter body 1 for maintaining the filter body 1 in an expanded bag-shape. The filter body 1 has an upper surface part 11 and a lower surface part 12. At least the lower surface part 12 of the filter body 1 has an inner layer part 13 formed of a non-woven cloth made of an olefin resin such as polyethylene or polypropylene, and an outer layer part 14 formed of a woven mesh.

The woven mesh of the outer layer part 14 typically is formed of a weaving cloth of a synthetic fiber such as nylon fiber, polyethylene fiber or polypropylene fiber, and has a mesh size sufficiently small for oil-water separation. The woven mesh can be formed of a mat weave, plain weave, twill weave, satin weave, and the like. The non-woven cloth of the inner layer part 13 is constituted so as to effectively remove a foreign material contained in the fuel. The non-woven cloth typically is formed of the fiber made of the olefin resin, and is formed in a mat or sheet form with various methods such as spun-bond method and melt-blown method.

In the embodiment, the woven mesh and non-woven cloth both are formed of a synthetic fiber. Both of the upper surface part 11 and lower surface part 12 may have the outer layer part 14 formed of a woven mesh and the inner layer part 13 formed of a non-woven cloth.

A sheet of filter base member 1′ having the inner layer part 13 and outer layer part 14 is folded in two such that the inner layer part 13 is on the inside. The filter base member 1′ is fused and bonded together at a fused portion 15 other than a folded portion 17, and an internal space 10 is formed between the folded portion 17 and the fused portion 15 to form the bag-shape filter body 1.

The filter base member 1′ is folded in two to face oppositely, and is fused with ultrasonic fusion or high-frequency fusion. The inner layer part 13 and outer layer part 14 may be spot fused at locations other than the fused portion 15 before the filter base member 1′ is formed in a bag-shape. Accordingly, it is possible to eliminate an unnecessary gap at a location other than the fused portion 15 between the two layer parts 13 and 14.

As a modified example, two sheets of the filter base member 1′ having the inner layer part 13 and outer layer part 14 may be fused and bonded together to form the bag-shape filter body 1.

In the filter device F according to the embodiment, the inner layer part 13 is formed of the non-woven cloth made of the olefin resin that is not soaked and swollen with fuel. Accordingly, it is possible to maintain a mesh size of the inner layer part 13, i.e. gaps between the intermeshed fibers of the non-woven cloth, at a desired size. As a result, it is possible to prevent the problem in which the mesh becomes smaller over time and a pressure of the fuel increases (greater pressure loss), thereby decreasing load on the fuel pump. Further, it is possible to prevent the problem in which the filter body is easy to get clogged with dust and dirt, and the pressure of the fuel increases, thereby decreasing load on the fuel pump.

The filter device F has the outer layer part 14 formed of the woven mesh. Accordingly, even if the lower surface part 12 of the filter body F rubs against a lower inner surface Ta of the fuel tank T when the lower inner surface Ta of the fuel tank T moves inwardly and outwardly (expansion and contraction of the fuel tank) due to a change in an internal pressure of the fuel tank T, the inner layer part 13 formed of the non-woven cloth does not directly contact. Accordingly, it is possible to prevent fraying in the non-woven cloth of the inner layer part 13 due to the rubbing.

The woven mesh of the outer layer part 14 may be made of the olefin resin such as polyethylene or polypropylene. Accordingly, the woven mesh of the outer layer part 14 tends not to be soaked and swollen with the fuel, and it is possible to maintain a mesh size of the woven mesh at a desired size. When the bag-shape filter body 1 is formed, the filter base member 1′ formed of the outer layer part 14 and inner layer part 13 is folded over with the inner layer part 13 on the inside, and the folded filter base member 1′ is fused. Accordingly, the inner layer part 13 is easily fused and integrated with the outer layer part 14 at the fused portion 15.

In the embodiment, one of warp and woof fibers of the woven mesh of the outer layer part 14 may be formed of polyethylene, and the other of the warp and woof fibers is formed of polypropylene. The non-woven cloth of the inner layer part 13 is formed of the fiber made of polyethylene or polypropylene. When the bag-shape filter body 1 is formed, the filter base member 1′ formed of the outer layer part 14 and inner layer part 13 is folded over with the inner layer part 13 on the inside, and the folded filter base member 1′ is fused. Accordingly, the inner layer part is easily fused and integrated with the outer layer part at the fused portion 15.

In the embodiment, the inner layer part 13 is formed of a non-woven cloth layer 13a formed with spun-bond method and a non-woven cloth layer 13b formed with melt-blown method. In general, a non-woven cloth formed with the melt-blown method has a mesh finer than that of a non-woven cloth made with the spun-bond method. A non-woven cloth formed with the spun-bond method has the fiber with a larger diameter and higher strength. Accordingly, the non-woven cloth layer 13b formed with the melt-blown method captures fine dust and dirt, and the non-woven cloth layer 13a formed with the spun-bond method provides the inner layer part with rigidity, so that it is easy to maintain the shape of the filter body.

In an embodiment shown in FIG. 12, the innermost layer (layer facing the internal space 10) is made of the non-woven cloth formed with the spun-bond method, and the layer between the innermost layer and the outer layer part 14 is made of the non-woven cloth formed with the melt-blown method. The space forming member 2 contacts only the non-woven cloth formed with the spun-bond method with higher fiber strength relative to the inner layer part 13. When the space forming member 2 moves due to the expansion and contraction of the fuel tank T, the friction of the movement does not affect the non-woven cloth formed with the melt-blown method. Accordingly, in the embodiment shown in FIG. 12, it is possible to prevent fraying of the non-woven cloth of the inner layer part 13 due to the friction.

Also, in the embodiment, the filter device F has a cylindrical socket body 3 made of a plastic and having one end part 30 connected to the fuel intake port P and the other end part 31 connected to a communicating hole 16 formed on the filter body 1. The cylindrical socket body 3 is formed in a cylindrical body with the end parts 30 and 31 opened. Also, the cylindrical socket body 3 is integrated with the filter body 1 such that the other end part 31 communicates with the communicating hole 16 formed in the upper surface part 11 of the filter body 1.

In the embodiment, the cylindrical socket body 3 is provided at the end part 31 with a first outer flange 32 and a second outer flange 33 formed around a cylindrical axis of the cylindrical socket body 3. A gap 34 is formed between the outer flanges 31 and 32. The cylindrical socket body 3 is installed on the filter body 1 in a state that an edge of the communicating hole 16 is inserted into the gap 34, that is, the edge of the communicating hole 16 is sandwiched between the first outer flange 32 and the second outer flange 33.

The first outer flange 32 contacts an outer surface of the upper surface part 11 of the filter body 1, and the second outer flange 33 contacts an inner surface of the upper surface part 11 of the filter body 1. The cylindrical socket body 3 is integrally formed on the filter base member 1′ with injection molding while the filter base member 1′ with the communicating hole 16 is inserted in a mold. The fuel flows into the internal space 10 of the filter body 1 after being filtered, and then is guided to the fuel intake port P through the cylindrical socket body 3.

In the embodiment, the space forming member 2 includes a main bone part 20 having a contour shape following an outer edge of the filter body 1; a connecting part 21 attached to the second outer flange 33 of the cylindrical socket body 3 in the filter body 1 and having a round hole-shape opening part 21a disposed immediately below the end part 31 of the cylindrical socket body 3; and a plurality of branch bone parts 22 for joining the connecting part 21 and the main bone part 20. Bump parts 23 project upwardly and downwardly from the main bone part 20 and the branch bone parts 22, so that the filter body 1 is maintained in a bag-shape.

In the embodiment, the connecting part 21 of the space forming member 2 is attached to the second outer flange 33 of the cylindrical socket body 3, so that the space forming member 2 is positioned on a side of the inner layer part 13 of the filter base member 1′ with the cylindrical socket body 3. Then, the filter base member 1′ is folded in two with the inner layer part 13 on the inside. The filter base member 1′ in the folded state is fused to the main bone part 20 of the space forming member 2 along the contour shape of the main bone part 20, thereby forming the bag-shape filter body 1. A portion of the filter base member 1′ at an outside of the fused portion 15 is removed to form the filter body 1 in a final shape.

As described above, according to the embodiments of the invention, the inner layer part of the filter body is formed of the non-woven cloth made of the olefin resin that tends not to be soaked and swollen with fuel. Accordingly, it is possible to maintain a mesh size of the inner layer part, i.e. gaps between mutually intermeshed fibers of the non-woven cloth, at a desired size. As a result, it is possible to prevent the problem in which the mesh becomes smaller over time and a pressure of the fuel increases, thereby decreasing load on the fuel pump.

While the invention has been explained with reference to the specific embodiments of the invention, the explanation is illustrative and the invention is limited only by the appended claims.

What is claimed is:

1. A fuel filter device to be attached to a fuel intake port in a fuel tank, comprising:
a bag-shape filter body having an upper surface part and a lower surface part, at least said lower surface part having an outer layer part formed of a woven mesh and an inner layer part formed of a non-woven cloth made of an olefin resin, and
a space forming member disposed in the filter body for maintaining the filter body in an expanded bag-shape.

2. A fuel filter device according to claim 1, wherein said olefin resin forming the inner layer part includes at least one of polyethylene and polypropylene.

3. A fuel filter device according to claim 1, wherein said outer layer part forming the woven mesh is made of an olefin resin including at least one of polyethylene and polypropylene.

4. A fuel filter device according to claim 3, wherein said outer layer part formed of the woven mesh includes warps and woofs, said warps or woofs being made of polyethylene and the other of the warps and woofs being made of polypropylene.

5. A fuel filter device according to claim 1, wherein said inner layer part formed of the non-woven cloth layer includes first and second portions, said first portion having a fiber thicker than that of the second portion and said second portion having a mesh size portion thinner than that of first portion.
